(19) United States
(12) Patent Application Publication
(10) Pub. No.: US 2007/0216499 A1
(43) Pub. Date: Sep. 20, 2007

(54) MICRO BAND-PASS FILTER

(75) Inventor: YEN-YI SHIH, Tu-Cheng (TW)

Correspondence Address: PCE INDUSTRY, INC.;ATT. CHENG-JU CHIANG JEFFREY T. KNAPP, 458 E. LAMBERT ROAD, FULLERTON, CA, 92835, US

(73) Assignee: HON HAI PRECISION INDUSTRY CO., LTD., Tu-Cheng (TW)

(21) Appl. No.: 11/565,641

(22) Filed: Dec. 1, 2006

(30) Foreign Application Priority Data
Mar. 17, 2006 (TW) 95109189

(51) Int. Cl. H01P 1/203

(52) U.S. Cl. 333/204

(57) ABSTRACT

A micro band-pass filter includes a first capacitor, a first resonator, a second capacitor, a second resonator, a third capacitor, a third resonator, an input portion, and an output portion. The first, second, and third resonators all have one end grounded, and have another end connected to the first capacitor, the second capacitor, and the third capacitor, respectively. The second resonator is disposed parallel to the first resonator. The third resonator is disposed between the first resonator and the second resonator and parallel thereto. The input portion connected to the first resonator is for inputting electromagnetic signals thereto. The output portion is electronically connected to the second resonator for outputting electromagnetic signals therefrom. The first capacitor and the second capacitor are disposed at one side of the filter, and the third capacitor is disposed at an opposite side of the filter.

### BACKGROUND

1. Field of the Invention

The present invention generally relates to a filter, and more particularly to a micro band-pass filter.

2. Related Art

It is well-known that a filter is able to eliminate interference signals for a communication product. Features of an ideal filter are that signal attenuation is zero within a pass band and becomes infinite within a cut-off band, and a transition from the pass band to the cut-off band should be as sharp as possible.

Typically, people improve an efficiency of a filter by adding resonators thereto. However, addition of resonators will increase an area of the filter, thereby increasing the size of the electronic product utilizing the filter.

Therefore, a heretofore unaddressed need exists in the industry to overcome the aforementioned deficiencies and inadequacies.

### SUMMARY

A micro band-pass filter includes a first capacitor, a first resonator, a second capacitor, a second resonator, a third capacitor, a third resonator, an input portion, and an output portion. One end of the first resonator is grounded, and another end is electronically connected to the first capacitor. One end of the second resonator is grounded, and another end is electronically connected to the second capacitor, the second resonator is disposed parallel to the first resonator. One end of the third resonator is grounded, and another end is electronically connected to the third capacitor. The third resonator is disposed between the first resonator and the second resonator and parallel thereto. The input portion is electronically connected to the first resonator for inputting electromagnetic signals thereto. The output portion is electronically connected to the second resonator for outputting electromagnetic signals therefrom. The first capacitor and the second capacitor are disposed at one side of the filter, and the third capacitor is disposed at an opposite side of the filter.

Other objectives, advantages and novel features of the present invention will be drawn from the following detailed description of preferred embodiments of the present invention with the attached drawings, in which:

### BRIEF DESCRIPTION OF THE DRAWINGS

FIG. 1 is a schematic diagram of a micro band-pass filter of an exemplary embodiment of the invention; and

FIG. 2 is a curve diagram showing a relationship between an amplitude of insertion and return loss and a frequency of electromagnetic signals traveling through the micro band-pass filter.

### DETAILED DESCRIPTION OF THE EMBODIMENTS

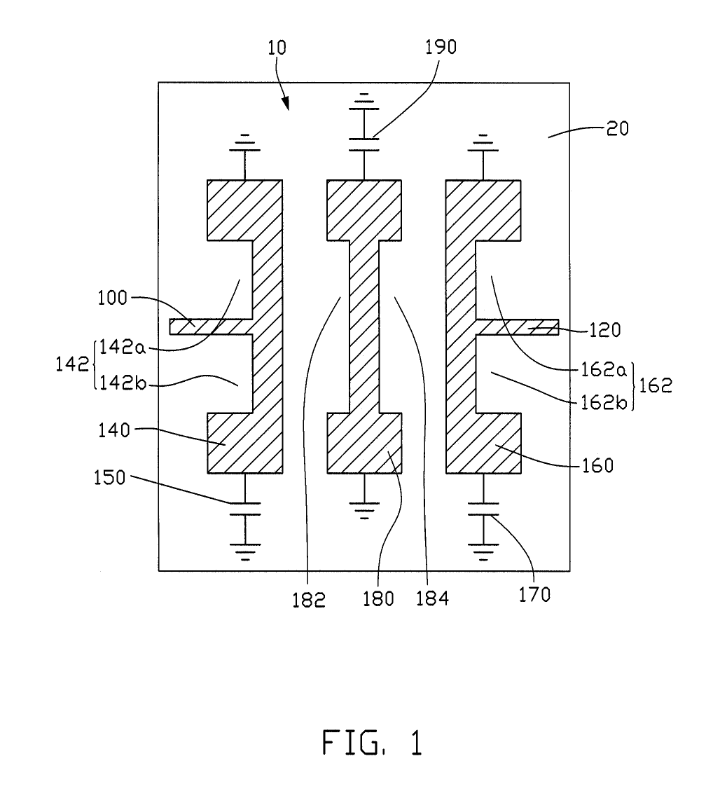

FIG. 1 is a schematic diagram of a micro band-pass filter 10 of an exemplary embodiment of the present invention.

In this embodiment, the micro band-pass filter 10 is arranged on a base plate 20, and includes an input portion 100, an output portion 120, a first resonator 140, a second resonator 160, and a third resonator 180. The third resonator 180 is disposed between the first resonator 140 and the second resonator 160, and the first resonator 140 and the second resonator 160 are symmetrical to each other with respect to the third resonator 180.

The input portion 100 is electronically connected to the first resonator 140 for inputting electromagnetic signals thereto.

The output portion 120 is aligned with the input portion 100, and is electronically connected to the second resonator 160 for outputting electromagnetic signals therefrom. The input portion 100 and the output portion 120 have matching impedances of about 50 Ohms.

One end of the first resonator 140 is grounded, and another end is grounded via a first capacitor 150. A first recessed portion 142 is formed between two ends of the first resonator 140, and the first recessed portion 142 is divided into two parts 142a and 142b by the input portion 100, which is disposed between the parts 142a and 142b.

The second resonator 160 is disposed parallel to the first resonator 140. In this embodiment, one end of the second resonator 160 is grounded, and another end is grounded via a second capacitor 170. A second recessed portion 162 is formed between two ends of the second resonator 160, and the second recessed portion 162 is divided into two parts 162a and 162b by the output portion 120, which is disposed between the parts 162a and 162b.

The third resonator 180 is disposed parallel to the first resonator 140 and the second resonator 160. In this embodiment, one end of the third resonator 180 is grounded, and another end is grounded via a third capacitor 190. The third resonator 180 includes a third recessed portion 182 and a fourth recessed portion 184. The third recessed portion 182 and the fourth recessed portion 184 are respectively disposed between two ends of the third resonator 180.

The first capacitor 150 and the second capacitor 170 are disposed at one side of the micro band-pass filter 10, and the third capacitor 190 is disposed at an opposite side of the micro band-pass filter 10. In this embodiment, values of the first capacitor 150, the second capacitor 170, and the third capacitor 190 are 4.7 picofarads (pF). The shape and the size of the first resonator 140 are the same as those of the second resonator 160. The shape of the first recessed portion 142 is the same as that of the second recessed portion 162, and the first recessed portion 142 and the second recessed portion 162 are symmetrically formed with respect to the third resonator 180. The shape of the third recessed portion 182 is the same as that of the fourth recessed portion 184, the third recessed portion 182 is exposed to the first resonator 140, and the fourth recessed portion 184 is exposed to the second resonator 160.

In this embodiment, the shortest distance between the first resonator 140 and the third resonator 180 is 0.28 millimeter (mm), and the shortest distance between the second resonator 160 and the third resonator 180 is 0.28 mm. Total area of the first resonator 140, the second resonator 160, and the third resonator 180 is 0.78 square mm. A total length, a total width, and a total area of the micro filter 10 are 2.51 mm, 2.48 mm, and 6.22 square mm, respectively.

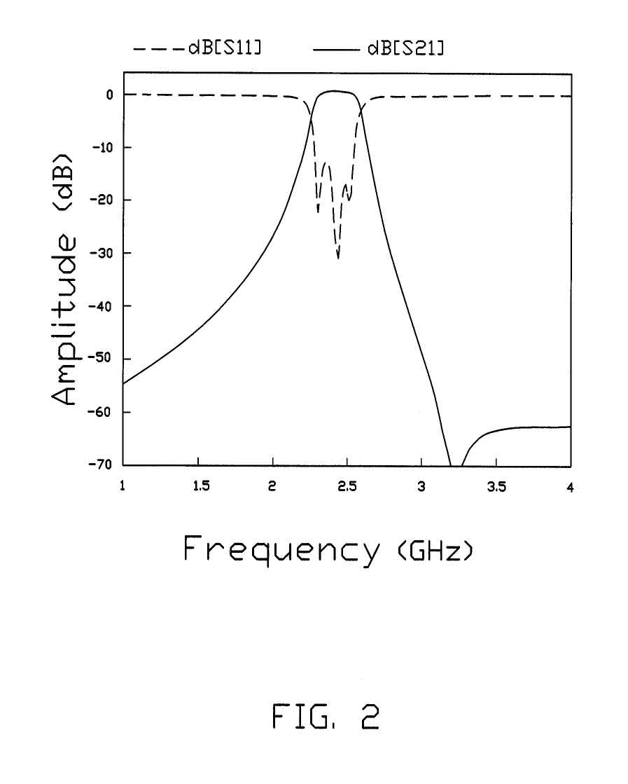

FIG. 2 is a curve diagram showing a relationship between amplitude of an insertion and return loss and a frequency of electromagnetic signals traveling through the micro band-pass filter 10. A horizontal axis represents the frequency (in GHz) of the electromagnetic signals traveling through the micro band-pass filter 10, and a vertical axis represents the amplitude of the insertion/return loss (in dB) of the micro band-pass filter 10.

In FIG. 2, the insertion loss is represented by a solid line S21, and the return loss is represented by a broken line S11. The curve S21 indicates a relationship between a value of an input power and a value of an output power of the electromagnetic signals traveling through the micro band-pass filter 10, and is represented by the following equation:

S21=−10*Log[(Input Power)/(Output Power)].

When the electromagnetic signals travels through the micro band-pass filter 10, a part of the input power is returned to a source of the electromagnetic signals. The part of the input power returned to the source of the electromagnetic signals is called a return power. The curve S11 indicates a relationship between the input power and the return power of the electromagnetic signals traveling through the micro band-pass filter 10, and is represented by the following equation:

S11=−10*Log[(Input Power)/(Return Power)].

For a filter, when a value of an output power of electromagnetic signals in a band-pass frequency range approaches a value of an input power thereof, and a return power of the electromagnetic signals is small, it means that a distortion of the electromagnetic signals is small and a performance of the micro band-pass filter 10 is good. That is, the smaller an absolute value of the insertion loss is, and the greater the absolute value of the return loss is, the better the performance of the filter is. As shown in FIG. 2, the micro band-pass filter 10 has a good performance as a band-pass filter. The absolute value of the insertion loss approaches a value of 0, and the absolute value of the return loss is greater than a value of 10.

In this embodiment, the first resonator 140, the second resonator 160, and the third resonator 180 are all symmetric step impedance resonators, and are closely disposed in parallel with each other, thereby an area of the micro band-pass filter 10 is relatively small. Moreover, the first resonator 140, the second resonator 160, and the third resonator 180 are respectively grounded via the first capacitor 150, the second capacitor 170, and the third capacitor 190, reducing lengths of the first capacitor 150, the second capacitor 170, and the third capacitor 190. The input portion 100 and the output portion 120 provide matching impedances, so the micro band-pass filter 10 does not require additional capacitors or impedances as a converter.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A micro band-pass filter, comprising:
a first capacitor;
a first resonator having one end grounded, and another end electronically connected to the first capacitor;
a second capacitor;
a second resonator having one end grounded, and another end electronically connected to the second capacitor, the second resonator disposed parallel to the first resonator;
a third capacitor;
a third resonator, disposed between the first resonator and the second resonator, having one end grounded, and another end electronically connected to the third capacitor, wherein the third resonator is disposed parallel to the first resonator and the second resonator;
an input portion electronically connected to the first resonator for inputting electromagnetic signals thereto; and
an output portion electronically connected to the second resonator for outputting electromagnetic signals therefrom;
wherein, the first capacitor and the second capacitor are disposed at one side of the filter, and the third capacitor is disposed at an opposite side of the filter.

2. The micro band-pass filter as recited in claim 1, wherein one end of the first capacitor is electronically connected to the first resonator and another end of the first capacitor is grounded.

3. The micro band-pass filter as recited in claim 1, wherein one end of the second capacitor is electronically connected to the second resonator and another end of the second capacitor is grounded.

4. The micro band-pass filter as recited in claim 1, wherein one end of the third capacitor is electronically connected to the third resonator and another end of the third capacitor is grounded.

5. The micro band-pass filter as recited in claim 1, wherein the input portion and the output portion have matching impedances of 50 Ohms.

6. The micro band-pass filter as recited in claim 1, wherein the input portion is aligned with the output portion.

7. The micro band-pass filter as recited in claim 1, wherein a shape of the first resonator is the same as that of the second resonator.

8. The micro band-pass filter as recited in claim 1, wherein the first resonator, the second resonator, and the third resonator are symmetric step impedance resonators.

9. The micro band-pass filter as recited in claim 1, wherein the first resonator comprises a first recessed portion disposed between two ends thereof, and the first recessed portion is divided into two parts by the input portion.

10. The micro band-pass filter as recited in claim 9, wherein the second resonator comprises a second recessed portion disposed between two ends thereof, and the second recessed portion is divided into two parts by the output portion.

11. The micro band-pass filter as recited in claim 10, wherein the first recessed portion and the second recessed portion are symmetrically formed with respect to the third resonator.

12. The micro band-pass filter as recited in claim 1, wherein the third resonator comprises a third recessed portion disposed between two ends thereof, and the third recessed portion is exposed to the first resonator.

13. The micro band-pass filter as recited in claim 12, wherein the third resonator further comprises a fourth recessed portion disposed between two ends thereof, and the fourth recessed portion is exposed to the second resonator.

14. A filter comprising:
an input portion for inputting electromagnetic signals to said filter;
an output portion spaced from said input portion for outputting said electromagnetic signals out of said filter;
a first resonator electrically connectable with said input portion to accept said electromagnetic signals from said input portion and spaced from said output portion;
a second resonator electrically connectable with said output portion to transmit said electromagnetic signals to said output portion and spaced from said first resonator; and
a third resonator disposed between said first and second resonators and spaced from said first and second resonators, respectively, for transmitting said electromagnetic signals between said first and second resonators; wherein
each of said first, second and third resonators comprises at least one recessed portion formed therein so as to have ends of said each of said first, second and third resonators larger than a middle of said each of said first, second and third resonators, respectively.

15. The filter as recited in claim 14, wherein said at least one recessed portion of said first resonator forms at a same side of said first resonator as said input portion and opposite to said third resonator, and said at least one recessed portion of said second resonator forms at a same side of said second resonator as said output portion and opposite to said third resonator.

16. The filter as recited in claim 14, wherein at least one of said ends of said first, second and third resonators electrically connects with a capacitor.

17. A filter comprising:
an input portion for inputting electromagnetic signals to said filter;
an output portion spaced from said input portion for outputting said electromagnetic signals out of said filter;
a first resonator electrically connectable with said input portion to accept said electromagnetic signals from said input portion and spaced from said output portion;
a second resonator electrically connectable with said output portion to transmit said electromagnetic signals to said output portion and spaced from said first resonator;
a third resonator disposed between said first and second resonators and spaced from said first and second resonators, respectively, for transmitting said electromagnetic signals between said first and second resonators; and
a capacitor electrically connectable with each of said first, second and third resonators, and connection arrangement of said capacitor with a selective one of said first, second and third resonators being different from another one of said first, second and third resonators neighboring said selective one of said first, second and third resonators.
